(19) United States
(12) Patent Application Publication
(10) Pub. No.: US 2025/0292465 A1
(43) Pub. Date: Sep. 18, 2025

(54) DATA ANALYSIS METHOD AND APPARATUS, A MEDIUM, AND AN ELECTRONIC DEVICE

(71) Applicant: Beijing Volcano Engine Technology Co., Ltd., Beijing (CN)

(72) Inventors: Kang HAN, Beijing (CN); Yinmeng ZHANG, Beijing (CN)

(21) Appl. No.: 19/077,351

(22) Filed: Mar. 12, 2025

(30) Foreign Application Priority Data
Mar. 13, 2024 (CN) 202410289284.4

(51) Int. Cl. G06T 11/60; G06F 3/0481; G06F 16/338; G06F 40/40

(52) U.S. Cl. CPC G06T 11/60; G06F 3/0481; G06F 16/338; G06F 40/40

(57) ABSTRACT

The present disclosure relates to a data analysis method and apparatus, a medium, and an electronic device. The data analysis method includes: displaying a data analysis page, wherein the data analysis page includes a conversation interaction region; and displaying, in the conversation interaction region, first reply content obtained for the first question text in response to a trigger operation for first question text inputted in the conversation interaction region, wherein the first question text is used for describing an analysis target, the first reply content includes at least one analysis indicator, and different analysis indicators have different analysis dimensions. The analysis indicator of the analysis target is automatically obtained in the form of a conversation, so that an operation user with weak experience is assisted in disassembling the analysis target of a service into analysis indicators, and the efficiency of data analysis is improved.

### CROSS-REFERENCE TO RELATED APPLICATION

This application claims the priority to and benefits of the Chinese Patent Application, No. 202410289284.4, which was filed on Mar. 13, 2024. The aforementioned patent application is incorporated herein by reference in its entirety.

### TECHNICAL FIELD

The present disclosure relates to the field of electronic information technology, and in particular, to a data analysis method and apparatus, a medium, an electronic device, and a program product.

### BACKGROUND

In a context of rapid development of the Internet, data analysis for data collected in applications is widely used in some online services, and it is beneficial to finely operate a related user by performing data analysis on the collected data.

In the related art, an operator usually faces with a new service analysis target. However, the operator has weak data analysis capability and lacks experience, and thus often obtains an analysis indicator used for measuring the service analysis target by offline inquiry to an experienced user, which takes a lot of time, resulting in low efficiency of data analysis.

### SUMMARY

This Summary is provided to introduce concepts in a brief form that are described in detail in the following Detailed Description section. This Summary section is not intended to identify key features or essential features of the claimed technical solution, nor is it intended to be used to limit the scope of the claimed technical solution.

In a first aspect, the present disclosure provides a data analysis method, including:
displaying a data analysis page, where the data analysis page includes a conversation interaction region; and
displaying, in the conversation interaction region, first reply content obtained for first question text in response to a trigger operation for the first question text inputted in the conversation interaction region, wherein the first question text is used for describing an analysis target, the first reply content includes at least one analysis indicator, and different analysis indicators have different analysis dimensions.

In a second aspect, the present disclosure provides a data analysis apparatus, including:
a first display module, configured to display a data analysis page, where the data analysis page includes a conversation interaction region; and
a second display module, configured to, display, in the conversation interaction region, first reply content obtained for the first question text in response to a trigger operation for first question text inputted in the conversation interaction region, wherein the first question text is used for describing an analysis target, the first reply content includes at least one analysis indicator, and different analysis indicators have different analysis dimensions.

In a third aspect, the present disclosure provides a computer-readable medium, storing a computer program thereon, where when the program is executed by a processing apparatus, the steps of the method in the first aspect are implemented.

In a fourth aspect, the present disclosure provides an electronic device, including:
a storage apparatus, storing a computer program thereon; and
a processing apparatus, configured to execute the computer program in the storage apparatus, to implement the steps of the method in the first aspect.

In a fifth aspect, the present disclosure provides a computer program product, including a computer program, where when the computer program is executed by a processor, the steps of the method in the first aspect are implemented.

Other features and advantages of the present disclosure will be described in detail in the following detailed description section.

### BRIEF DESCRIPTION OF DRAWINGS

The above and other features, advantages, and aspects of various embodiments of the present disclosure will become more apparent in combination with the drawings and with reference to the following specific embodiments. Throughout the drawings, the same or similar reference numerals denote the same or similar elements. It should be understood that the drawings are schematic and that parts and elements are not necessarily drawn to scale. In the drawings:

FIG. 1 is a flowchart of a data analysis method according to an exemplary embodiment of the present disclosure;

FIG. 2 is an interface diagram of an interactive conversation region according to an exemplary embodiment of the present disclosure;

FIG. 3 is another interface diagram of an interactive conversation region according to an exemplary embodiment of the present disclosure;

FIG. 4 is an interface diagram of a chart detail panel according to an exemplary embodiment of the present disclosure;

FIG. 5 is another interface diagram of an interactive conversation region according to an exemplary embodiment of the present disclosure;

FIG. 6 is another interface diagram of an interactive conversation region according to an exemplary embodiment of the present disclosure;

FIG. 7 is a schematic diagram of a data analysis page according to an exemplary embodiment of the present disclosure;

FIG. 8 is a schematic diagram of a process of determining a target analysis parameter in an analysis parameter including a plurality of indicator apertures according to an exemplary embodiment of the present disclosure;

FIG. 9 is a schematic diagram of a process of regenerating reply content according to an exemplary embodiment of the present disclosure;

FIG. 10 is a block diagram of a data analysis apparatus according to an exemplary embodiment of the present disclosure; and

FIG. 11 is a schematic structural diagram of an electronic device according to an exemplary embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and embodiments of the present disclosure are only for exemplary purposes and are not intended to limit the scope of protection of the present disclosure.

It should be understood that the various steps described in the method implementations of the present disclosure may be performed in different orders and/or in parallel. In addition, the method implementations may include additional steps and/or omit the steps shown. The scope of the present disclosure is not limited in this respect.

As used herein, the term “include/include” and its variants are open-ended inclusions, i.e., “include/include but not limited to”. The term “based on” is “based, at least in part, on”. The term “an embodiment” means “at least one embodiment”; the term “another embodiment” means “at least one additional embodiment”; and the term “some embodiments” means “at least some embodiments”. Relevant definitions of other terms will be given in the following description.

It should be noted that concepts such as “first” and “second” mentioned in the present disclosure are only used to distinguish different apparatuses, modules, or units, and are not used to limit the order or interdependence of functions performed by these apparatuses, modules, or units.

It should be noted that the modifiers “one” and “a plurality of” mentioned in the present disclosure are illustrative rather than restrictive, and those skilled in the art should understand that unless the context clearly indicates otherwise, they should be understood as “one or more”.

The names of messages or information exchanged between apparatuses in the implementations of the present disclosure are only for illustrative purposes and are not intended to limit the scope of these messages or information.

It can be understood that, before using the technical solutions disclosed in the embodiments of the present disclosure, the user should be informed of the type, use scope, use scenario, etc. of personal information involved in the present disclosure in an appropriate manner in accordance with relevant laws and regulations, and the user's authorization should be obtained.

For example, when an active request from a user is received, prompt information is sent to the user to clearly prompt the user that the operation requested to be performed will require acquisition and use of the user's personal information. Thereby, the user can independently choose, according to the prompt information, whether to provide the personal information to the software or hardware such as the electronic device, the application, the server, or the storage medium that performs the operations of the technical solutions of the present disclosure.

As an optional but non-limiting implementation, the manner of sending the prompt information to the user in response to receiving the active request from the user may be, for example, in a form of a pop-up window, and the prompt information may be presented in text in the pop-up window. In addition, the pop-up window may further include a selection control for the user to choose whether to “agree” or “disagree” to provide the personal information to the electronic device.

It can be understood that the above process of notifying and obtaining the user's authorization is only illustrative and does not limit the implementations of the present disclosure, and other manners that satisfy relevant laws and regulations may also be applied to the implementations of the present disclosure.

At the same time, it can be understood that the data involved in the technical solutions (including but not limited to the data itself, the acquisition or use of the data) should comply with the requirements of corresponding laws, regulations, and related provisions.

In the related art, an analysis target may be learned from analysis indicators of different analysis dimensions. Taking the analysis target being reasons for users to place an order in a sales scenario as an example, the analysis may be performed, from a source channel, on ordered products and an order placing rate of different source channels to compare which channels' users are more likely to place an order and which channels' users have a higher order placing amount; the analysis may be performed, from a transaction volume, on ordered products and an order placing rate of different transaction volume intervals to compare which transaction volume intervals' users are more likely to place an order and which transaction volume intervals' users have a higher order placing amount; and the analysis may be performed, from a product category, on ordered products and an order placing rate of different product categories to compare which product categories' users are more likely to place an order and which product categories' users have a higher order placing amount.

It should be noted that, the ordered products and the order placing rate of the source channels, the ordered products and the order placing rate of different transaction volume intervals analyzed from the transaction volume, and the ordered products and the order placing rate of different product categories in the above example are all analysis indicators obtained from different analysis dimensions.

However, for some operation users with weak analysis experience, an analysis indicator used for measuring a service analysis target is usually obtained by offline inquiry to an experienced user, which takes a lot of time and leads to low efficiency of data analysis. In addition, for different analysis indicators, there are different indicator apertures and thus different analysis parameters. An operation personnel needs to determine the analysis parameters of the analysis indicator by checking a table, which further affects the efficiency of data analysis. The operation user may also purchase a professional value-added service, but undoubtedly the cost of data analysis is increased.

In view of this, embodiments of the present disclosure provide a data analysis method and apparatus, a medium, an electronic device, and a program product, which improve the efficiency of data analysis and reduce the configuration cost of analysis parameters required for analysis indicators.

Embodiments of the present disclosure will be further explained and illustrated hereunder with reference to the drawings.

FIG. 1 is a flowchart of a data analysis method according to an exemplary embodiment of the present disclosure. The method may be performed by a data analysis apparatus, wherein the data analysis apparatus may be implemented by software and/or hardware, and may be configured in an electronic device, typically, may be configured in a mobile phone or a tablet computer. Referring to FIG. 1, the data analysis method may include the following steps.

Step 110: displaying a data analysis page, wherein the data analysis page includes a conversation interaction region; and

Step 120: displaying, in the conversation interaction region, first reply content obtained for first question text in response to a trigger operation for the first question text inputted in the conversation interaction region, wherein the first question text is used for describing an analysis target, the first reply content includes at least one analysis indicator, and different analysis indicators have different analysis dimensions.

It should be noted that, the data analysis page may be a page in a data analysis platform which is used for supporting parameter configuration for data analysis, displaying a visual chart of service data, and providing conversation interaction. The data analysis platform is a platform may provide functions such as data access, data processing, data storage, query and retrieval, analysis and mining, and application interfaces. In addition, different data analysis platforms may be built for different application scenarios, such as a data analysis platform for product sales, which is not limited in the present disclosure.

It can be understood that, the conversation interaction region in the data analysis page is used for providing conversation interaction. An intelligent object may be provided in the conversation interaction region, and the intelligent object may receive text information inputted from the outside world and process the received text information with an integrated data generation model to generate knowledge information corresponding to the text information. The first question text may be inputted by voice, or may be inputted in a text box, and corresponding first question text may be obtained by performing voice-to-text conversion on voice information inputted by voice.

It should be noted that, the analysis indicator is a parameter used for measuring the analysis target, and the analysis target may be determined according to the analysis indicator. The analysis target may usually be considered from different analysis dimensions, and different analysis dimensions correspond to different analysis indicators. As an example, the analysis dimensions may be regions, sources, and the like.

The trigger operation for the first question text may be triggered by a question answering control in the conversation interaction region. As an example, taking the first question text inputted in a text box as an example, the question answering control is used for transmitting the first question text to the intelligent object, and after it is determined, based on the question answering control, that the first question text is sent to the intelligent object, it is determined that the trigger operation for the first question text inputted in the conversation interaction region is performed.

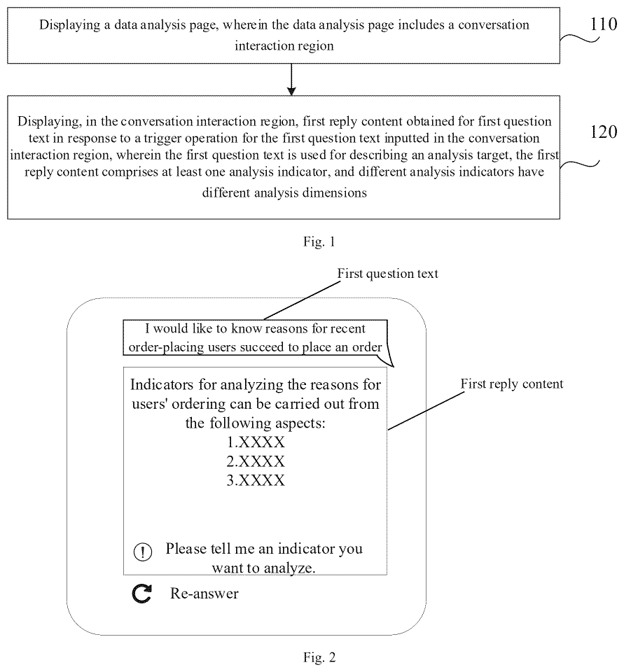

As an example, the conversation interaction region shown in FIG. 2 displays the first question text and the first reply content. In FIG. 2, the first question text “I would like to know reasons for recent order-placing users succeed to place an order” may be measured from the analysis indicators of different dimensions, and the first reply content contains content that can answer the first question text from the analysis indicators of different dimensions.

It should be noted that, the first reply content is obtained by analyzing the first question text based on a capability of natural language understanding. Specifically, the first reply content may be obtained by processing the first question text with the above data generation model.

In a service scenario, most users cannot accurately understand the analysis target and thus obtain the analysis indicator used for measuring the analysis target. Therefore, with the above method, the analysis indicators of different analysis dimensions of the analysis target are automatically obtained in a manner of a conversation, so that an operation user with weak experience is assisted in disassembling the analysis target of a service into analysis indicators, and the efficiency of data analysis is improved without the need for the user to obtain the analysis indicator in an offline inquiry manner.

In some embodiments, the above data analysis method may further include the following steps: i. searching in a chart library for whether there is a target chart matching the target analysis indicator in response to a trigger operation for second question text which is inputted in the conversation interaction region and is related to a target analysis indicator, wherein the second question text is used for querying the target chart corresponding to the target analysis indicator; and displaying second reply content in the conversation interaction region in response to searching out the target chart, wherein the second reply content includes the target chart

It should be noted that, the target analysis indicator may be one or more analysis indicators in the first reply content. In addition, the target analysis indicator may also be an analysis indicator directly inputted by the user in the conversation interaction region.

Similar to the first question text, the trigger operation for the second question text may be triggered by the question answering control in the conversation interaction region. As an example, taking the second question text inputted in the text box as an example, after the second question text is inputted in the text box, and after determining, based on the question answering control, the second question text is transmitted to the intelligent object, it is determined that the trigger operation for the second question text which is inputted in the conversation interaction region and is related to the target analysis indicator is performed.

It should be noted that, the chart library stores data related to charts, such as charts obtained by different operation users based on analysis of the data analysis platform, and names corresponding to the charts.

As an example, the first question text, the second question text, and the data related to the charts stored in the chart library may be matched, so as to determine whether the target chart matching the target analysis indicator can be searched out in the chart library. As an example, the target chart is a chart with a highest matching degree in the chart library.

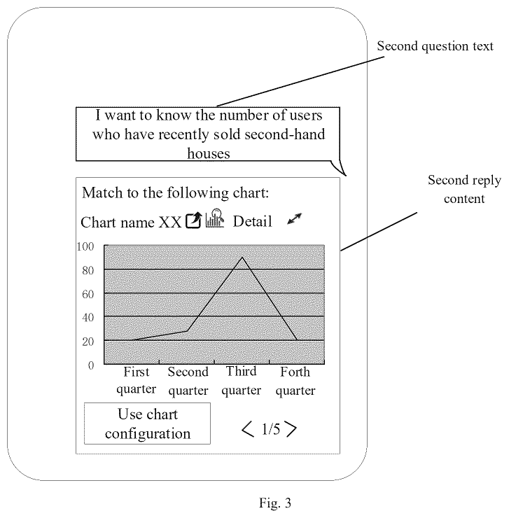

As an example, the conversation interaction region shown in FIG. 3 displays the second question text and the second reply content. The second reply content includes the target chart, a chart name XX related to the target, and some controls. These controls support certain operations on the chart. Reference may be made to related examples below, and details are not described herein in the embodiment.

With above manner, the capability of natural language understanding is used to accurately match the existing charts with the analysis indicator which is currently queried by the user, so that the reuse rate of the existing charts is improved.

In some embodiments, the above data analysis method may further include the following step: displaying a chart detail panel in a floating manner on an upper layer of the target chart in response to a trigger operation for a detail control in the target chart, wherein the chart detail panel includes chart attribute information, and the chart attribute information is used for assisting a user in judging credibility of the target chart.

As an example, the chart attribute information may include a dashboard to which the chart belongs, an indicator included in the chart, and time information of the latest modification of the chart.

The dashboard to which the chart belongs describes a service scenario for the chart. In addition, the user may click on information shown in the dashboard to which the chart belongs, and then link to a data dashboard of the corresponding service scenario. It should be noted that the data dashboard is a carrier for data visualization.

The indicator included in the chart describes an analysis parameter corresponding to the chart.

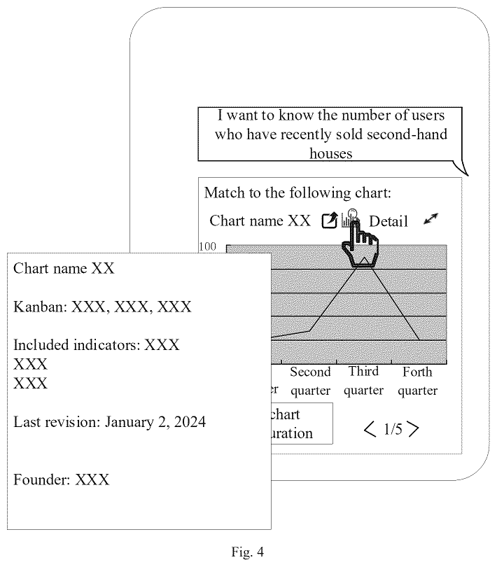

As an example, in the chart detail panel shown in FIG. 4, the operation user may hover a mouse over a control corresponding to “detail”, so that the chart detail panel is displayed in a floating manner on the upper layer of the target chart.

With above manner, based on the chart attribute information included in the chart detail panel, the operation user may be assisted in determining whether the target chart can be used for the analysis of the analysis target when the operation user has doubts about the credibility of the target chart.

In some embodiments, there may be a plurality of target charts, and the step of displaying the second reply content in the conversation interaction region in response to searching out the target chart may include: displaying the second reply content in the conversation interaction region in response to searching out a plurality of the target charts, wherein the second reply content includes a target chart with a highest matching degree and a switching control for switching a chart; and witching, in the conversation interaction region, to displaying other target charts associated with a currently displayed target chart in response to a switching operation for the switching control.

As an example, a chart with a matching degree greater than a preset threshold with the target analysis indicator may be used as the target chart. As another example, a chart with a matching degree ranking in top preset number may be used as the target chart, and the preset number may be, for example, 5.

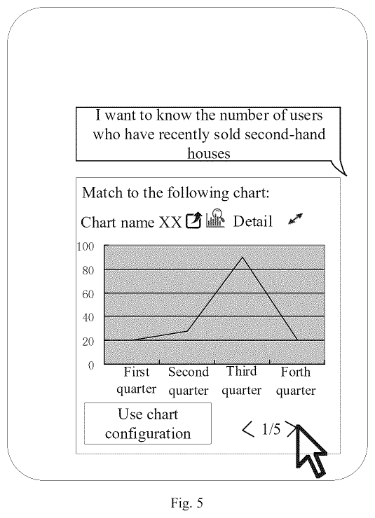

As an example, referring to the conversation interaction region shown in FIG. 5, there are five target charts. The user may click on a control “>” shown in FIG. 5 to jump to the next target chart associated with the currently displayed target chart. In addition, the user may click on a control “<” shown in FIG. 5 to jump to the previous target chart associated with the currently displayed target chart.

It should be noted that, the plurality of target charts are arranged according to the matching degree. A corresponding matching degree of a target chart is higher than a matching degree corresponding to a next target chart associated with the target chart, and the corresponding matching degree of the target chart is lower than a matching degree corresponding to a previous target chart associated with the target chart.

With above method, a plurality of target charts are provided for the user to view, so that the user is ensured to find a chart that meets the analysis target from various charts for reuse, and the accuracy of data analysis is further improved.

In some embodiments, the step of displaying the second reply content in the conversation interaction region in response to searching out the target chart may be implemented in the following manner: determining whether there is a permission to browse the target chart in response to searching out the target chart; displaying the second reply content in the conversation interaction region in response to determining that there is the permission to browse the target chart, wherein the second reply content includes the target chart; and displaying the second reply content in the conversation interaction region in response to determining that there is no permission to browse the target chart, wherein the second reply content includes a chart name of the target chart, the detail control and an application control for acquiring the permission to browse the target chart.

It should be noted that, in an actual service scenario, after building a data dashboard, an operation user may set an access permission of the data dashboard or a chart in the data dashboard for the sake of data security. For example, some users are authorized to access the data dashboard or the chart in the data dashboard. Therefore, after the target chart is searched out, it is necessary to determine whether the user has the permission to browse the target chart.

As an example, if the user has the permission to browse the target chart, reference may be made to the example shown in FIG. 4 for the second reply content obtained by the user.

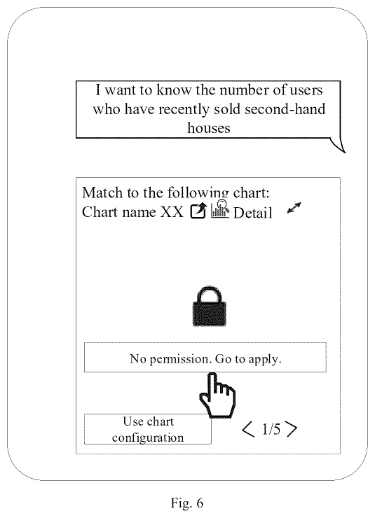

As an example, compared with FIG. 4, in the conversation interaction region shown in FIG. 6, the display of the target chart is hidden, and only ordinary attribute information of the chart that does not affect data security is displayed, such as the chart name of the target chart, and the operation user may click on an application control of “no permission, go to apply” to request the owner of the target chart to authorize the permission to browse the target chart.

In addition, still referring to FIG. 6, the user may hover the mouse over the control corresponding to the “detail”, and the chart detail panel is displayed in a floating manner on the upper layer of the target chart, so that the user may, based on the credibility of the target chart, request to the owner of the target chart to authorize the permission to browse the target chart when the user has trust in the target chart.

With above method, not only the data security of the target chart can be protected, but also an interface can be provided for the user to request the browse permission of the target chart, so that the practicability of the overall solution is improved.

In some embodiments, the data analysis page further includes an analysis parameter configuration region and an analysis result display region, the analysis parameter configuration region displays a configuration item configured for an analysis parameter corresponding to the analysis indicator, and the analysis result display region is used for displaying an analysis result of data analysis performed based on the configured analysis parameter, such as a chart.

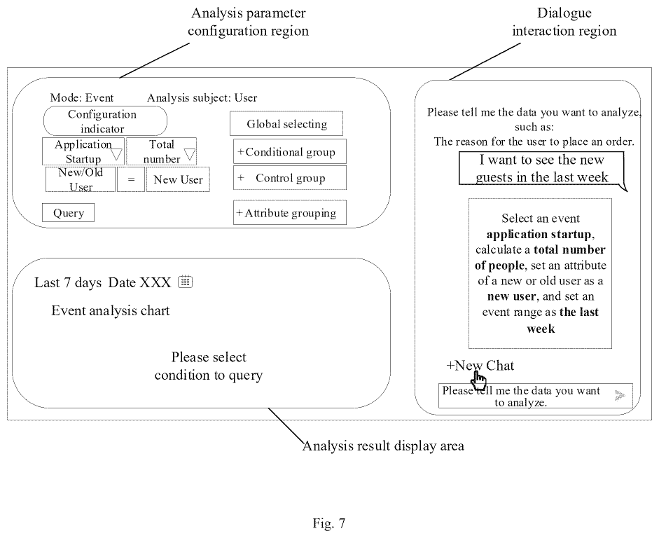

As an example, the data analysis page shown in FIG. 7 includes the conversation interaction region, the analysis parameter configuration region, and the analysis result display region.

On this basis, the above data analysis method may further include the following steps: in response to failing to search out the target chart, displaying the second reply content in the conversation interaction region, wherein the second reply content includes an analysis parameter determined for the target analysis indicator; and filling the analysis parameter into the corresponding configuration item.

It should be noted that, the analysis parameter determined for the target analysis indicator may be obtained through the above intelligent object. As an example, the intelligent object may provide a data generation model, and the data generation module may learn based on a technical document of the analysis indicator and the analysis parameter corresponding to the analysis indicator, and then process the second question text based on the knowledge learned, so as to obtain the corresponding analysis parameter. It can be understood that the second question text includes the analysis indicator.

Continuing to refer to FIG. 7, for the second question text “I want to see new customers in the last week”, the second reply content given by the intelligent object is “Select an event application startup, calculate a total number of people, set an attribute of a new or old user as a new user, and set an event range as the last week”, and the intelligent object spontaneously fills the analysis parameter in the second reply content into the corresponding configuration item.

With above manner, the analysis parameter in the analysis indicator is automatically obtained and configured, and the user does not need to perform offline query and confirmation based on the technical document of the analysis indicator and the analysis parameter corresponding to the analysis indicator, so that the efficiency of data analysis is further improved.

In some embodiments, the above data analysis method may further include the following steps: in response to determining that the analysis parameter includes analysis parameters of a plurality of indicator apertures, displaying third reply content in the conversation interaction region, where the third reply content includes an analysis parameter corresponding to each of the indicator apertures; in this case, the step of filling the analysis parameter into the corresponding configuration item may be implemented in the following manner: in response to a trigger operation for an analysis parameter corresponding to a target indicator aperture, filling the analysis parameter corresponding to the target indicator aperture into the corresponding configuration item.

The analysis parameter may include an analysis object and an analysis method. The analysis object may be data that needs to be analyzed, such as an event that needs to be analyzed, such as an application opening event, a login event, and the like. The analysis method refers to a manner of analyzing data, such as a comparison manner, that is, data may be compared between regions, data may be compared between devices, and the like.

It should be noted that, the indicator aperture is a standard adopted when counting data, and for the same analysis indicator, indicator apertures adopted by different users may be inconsistent, which leads to possible inconsistency of analysis parameters. For example, taking the analysis indicator being “New customers in the last week” as an example, users may have different definitions of new customers, and thus the indicator apertures of the analysis indicator are different. It should be understood that, the difference in the indicator apertures of the analysis indicator may be specifically represented by a difference in a certain analysis parameter used for determining the analysis indicator.

For example, in the analysis parameter of the analysis indicator “New customers in the last week”, taking the analysis parameter being an event as an example, a user who has performed an event of starting an application may be regarded as a new customer, or a user who has performed an event of user login may be regarded as a new customer, that is, for the former, the analysis parameter corresponding to the configuration item of the event is the “Application startup” event, and for the latter, the analysis parameter corresponding to the configuration item of the event is the “User login” event. Since the analysis parameters corresponding to the configuration item of the event are different between the two, the difference between the indicator apertures of the two is reflected.

The analysis parameters corresponding to different indicator apertures may be displayed independently in the third reply content, so that the user may perform a click operation for the content of the analysis parameter corresponding to the target indicator aperture in the third reply content with the mouse, thereby performing the trigger operation for the analysis parameter corresponding to the target indicator aperture.

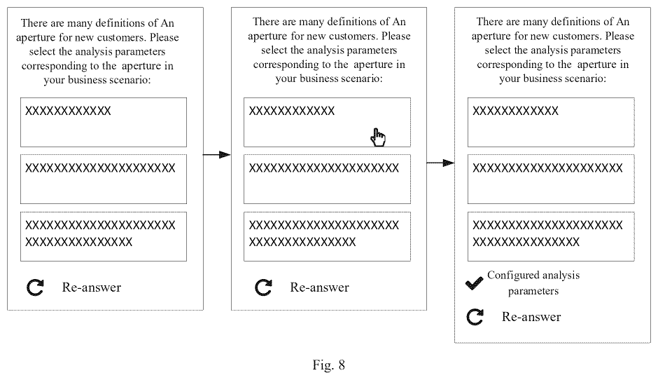

As an example, the analysis parameter in each indicator aperture may be displayed in the third reply content. Referring to the process of determining the target analysis parameter in the analysis parameter including a plurality of indicator apertures shown in FIG. 8, the leftmost diagram shows the analysis parameters corresponding to the three indicator apertures respectively. It should be noted that there is at least one different analysis parameter in the three indicator apertures, and specifically, the analysis objects may be different.

The user triggers a click operation for the analysis parameter corresponding to the target indicator aperture based on the analysis parameters corresponding to the three indicator apertures shown in the leftmost diagram, and the target indicator aperture is the first indicator aperture from top to bottom in the third reply content shown in FIG. 8.

In response to the trigger operation for the analysis parameter corresponding to the first indicator aperture, the electronic device fills the analysis parameter corresponding to the first indicator aperture into the corresponding configuration item.

With above method, when there are different indicator apertures for the target analysis indicator, the user is provided with the configuration of the analysis parameters in different indicator apertures, so that the user can perform disambiguation, i.e., make a secondary selection, on the analysis parameters, thereby automatically configuring the analysis parameter required by the user.

In some embodiments, referring to the schematic diagram shown in FIG. 8, in response to the trigger operation for the analysis parameter corresponding to the first indicator aperture, the electronic device may also display, in the conversation interaction region, the content corresponding to the analysis parameter corresponding to the indicator aperture selected by the user and the content corresponding to the analysis parameter corresponding to the indicator aperture not selected by the user, in different styles.

In this way, the user can intuitively distinguish the analysis parameter corresponding to the selected indicator aperture from the analysis parameter corresponding to the unselected indicator aperture.

In some embodiments, the above method may further include: displaying fourth reply content in the conversation interaction region in response to a re-answer operation for reply content, wherein the fourth reply content includes new content obtained for question text corresponding to the reply content.

It should be understood that, the reply content in this embodiment may be any reply content that has been output by the intelligent object in the conversation interaction region.

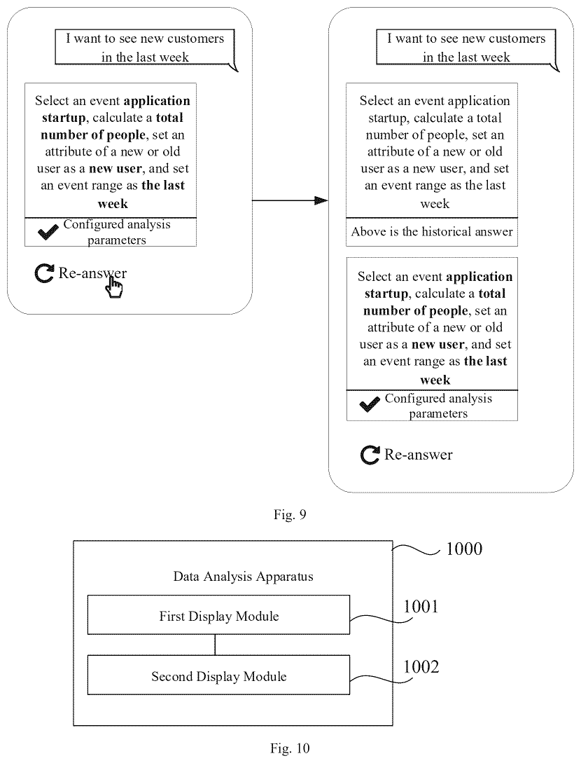

Referring to the example diagram shown in FIG. 9, the user may perform a click operation based on a control “re-answer” displayed in the conversation interaction region, so as to trigger the re-answer operation for the reply content. Thereby, the conversation interaction region further displays new content of re-answer given based on “I want to see new customers in the last week”.

With above method, when the user is not satisfied with the current reply, the user is supported to re-request the electronic device to re-reply to the question that has been raised, so as to meet the diverse needs of the user for data analysis.

In some embodiments, the step of displaying the fourth reply content in the conversation interaction region in response to the re-answer operation for the reply content may be implemented in the following manner: displaying the reply content and the fourth reply content in different preset display styles in response to the re-answer operation for the reply content.

The preset display style may be a style set by the user or may be a style defaulted by the data analysis platform. The preset display style may be a color sample and a font style, etc.

It should be understood that when the user triggers the re-answer operation, it means that the user is not satisfied with the reply content, and the preset display style may be used to reduce the user's attention to the reply content and increase the attention to the fourth reply content. As an example, still referring to the schematic diagram shown in FIG. 9, for the reply content for which the re-answer operation is performed, the display color of its font may be set to gray. For the new reply content, the display color of its font is set to black.

With above manner, for information that the user does not want to adopt and new content information, different display styles may be used for display, so that the user's attention to information that the user does not want to adopt can be reduced, thereby highlighting useful information that the user wants to pay more attention to.

In some embodiments, a prompt message of the configured analysis parameter may be displayed, such as “configured analysis parameter” as shown in FIG. 9. In this way, the user can be reminded that the configuration of the analysis parameter has been automatically completed.

In some embodiments, the configuration of the analysis parameter may require multiple rounds of conversations between the intelligent object and the user. When the intelligent object replies to the question text raised by the user, the intelligent object may usually give a reply in combination with a context. In order to avoid the influence of a context of a historical conversation on a new conversation, the conversation interaction region may be provided with a control for clearing the conversation, and the user performs a trigger operation for the control to clear a current conversation record, so that a subsequent new conversation will not be affected by a previous conversation context.

As an example, still referring to FIG. 7, the user may click on a control “+new chat” shown in FIG. 7 to achieve the purpose of clearing the current conversation record.

Based on the same concept, an embodiment of the present disclosure provides a data analysis apparatus. FIG. 10 is a block diagram of a data analysis apparatus according to an exemplary embodiment of the present disclosure. Referring to FIG. 10, the data analysis apparatus 1000 includes:

a first display module 1001, configured to display a data analysis page, wherein the data analysis page includes a conversation interaction region; and

a second display module 1002, configured to, display, in the conversation interaction region, first reply content obtained for the first question text in response to a trigger operation for first question text inputted in the conversation interaction region, wherein the first question text is used for describing an analysis target, the first reply content includes at least one analysis indicator, and different analysis indicators have different analysis dimensions.

Optionally, the data analysis apparatus 1000 further includes:
a first response module, configured to, search in a chart library for whether there is a target chart matching the target analysis indicator in response to a trigger operation for second question text which is inputted in the conversation interaction region and is related to a target analysis indicator, wherein the second question text is used for querying the target chart corresponding to the target analysis indicator; and
a third display module, configured to, display second reply content in the conversation interaction region in response to searching out the target chart, wherein the second reply content includes the target chart.

Optionally, the data analysis apparatus 1000 further includes:
a fourth display module, configured to, display a chart detail panel in a floating manner on an upper layer of the target chart in response to a trigger operation for a detail control in the target chart, wherein the chart detail panel includes chart attribute information, and the chart attribute information is used for assisting a user in judging credibility of the target chart.

Optionally, there are a plurality of the target charts, and the third display module is specifically configured to:
display the second reply content in the conversation interaction region in response to searching out a plurality of the target charts, wherein the second reply content includes a target chart with a highest matching degree and a switching control for switching a chart; and
switch, in the conversation interaction region in response to a switching operation for the switching control, to displaying other target charts associated with a currently displayed target chart.

Optionally, the third display module is specifically configured to:
determine whether there is a permission to browse the target chart in response to searching out the target chart;
display the second reply content in the conversation interaction region in response to determining that there is the permission to browse the target chart, wherein the second reply content includes the target chart; and
display the second reply content in the conversation interaction region in response to determining that there is no permission to browse the target chart, wherein the second reply content includes a chart name of the target chart, the detail control and an application control for acquiring the permission to browse the target chart.

Optionally, the data analysis page further includes an analysis parameter configuration region, the analysis parameter configuration region displays a configuration item configured for an analysis parameter corresponding to the analysis indicator, and the data analysis apparatus 1000 further includes:
a fifth display module, configured to, display the second reply content in the conversation interaction region in response to failing to search out the target chart, wherein the second reply content includes an analysis parameter determined for the target analysis indicator; and
a filling module, configured to fill the analysis parameter into the corresponding configuration item.

Optionally, the data analysis apparatus 1000 further includes:
a sixth display module, configured to, display third reply content in the conversation interaction region in response to determining that the analysis parameter includes analysis parameters of a plurality of indicator apertures, wherein the third reply content includes an analysis parameter corresponding to each of the indicator apertures;
wherein the filling module is specifically configured to, in response to a trigger operation for an analysis parameter corresponding to a target indicator aperture, fill the analysis parameter corresponding to the target indicator aperture into the corresponding configuration item.

Optionally, the data analysis apparatus 1000 further includes:
a seventh display module, configured to, display fourth reply content in the conversation interaction region in response to a re-answer operation for reply content, wherein the fourth reply content includes new content obtained for question text corresponding to the reply content.

Optionally, the seventh display module is specifically configured to:
display the reply content and the fourth reply content in different preset display styles in response to the re-answer operation for the reply content.

The implementations of the modules in the above data analysis apparatus 1000 may refer to the above related embodiments, and details are not described herein in this embodiment.

Based on the same concept, an embodiment of the present disclosure provides a -readable medium, storing a computer program thereon, where when the program is executed by a processing apparatus, the steps of the data analysis method in the above embodiments are implemented.

Based on the same concept, an embodiment of the present disclosure provides a computer program product, including a computer program, where when the computer program is executed by a processor, the steps of the data analysis method in the above embodiments are implemented.

Based on the same concept, an embodiment of the present disclosure provides an electronic device, including:
a storage apparatus, storing a computer program thereon; and
a processing apparatus, configured to execute the computer program in the storage apparatus, to implement the steps of the data analysis method in the above embodiments.

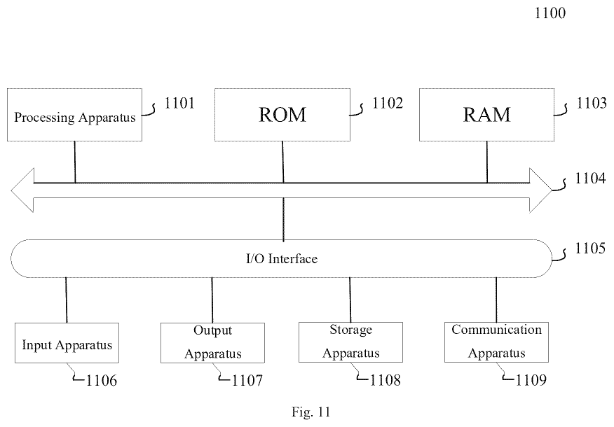

Reference is made to FIG. 11 below, which illustrates a schematic structural diagram of an electronic device 1100 suitable for implementing an embodiment of the present disclosure. The terminal device in the embodiments of the present disclosure may include, but is not limited to, mobile terminals such as a mobile phone, a notebook computer, a digital broadcast receiver, a PDA (Personal Digital Assistant), a PAD (tablet computer), a PMP (Portable Multimedia Player), a vehicle-mounted terminal (such as a vehicle-mounted navigation terminal), etc., and fixed terminals such as a digital TV, a desktop computer, etc. The electronic device shown in FIG. 11 is only an example and should not bring any limitation to the functions and use scope of the embodiments of the present disclosure.

As shown in FIG. 11, the electronic device 1100 may include a processing apparatus (such as a central processing unit, a graphics processing unit, etc.) 1101, which may perform various appropriate actions and processing according to a program stored in a read-only memory (ROM) 1102 or a program loaded from a storage apparatus 1108 into a random access memory (RAM) 1103. Various programs and data required for the operation of the electronic device 1100 are also stored in the RAM 1103. The processing apparatus 1101, the ROM 1102, and the RAM 1103 are connected to each other through a bus 1104. An input/output (I/O) interface 1105 is also connected to the bus 1104.

Generally, the following apparatuses may be connected to the I/O interface 1105: an input apparatus 1106 including, for example, a touchscreen, a touchpad, a keyboard, a mouse, a camera, a microphone, an accelerometer, a gyroscope, etc.; an output apparatus 1107 including, for example, a liquid crystal display (LCD), a loudspeaker, a vibrator, etc.; a storage apparatus 1108 including, for example, a magnetic tape, a hard disk, etc.; and a communication apparatus 1109. The communication apparatus 1109 may allow the electronic device 1100 to perform wireless or wired communication with other devices to exchange data. Although FIG. 11 shows the electronic device 1100 having various apparatuses, it should be understood that it is not required to implement or have all of the shown apparatuses. More or fewer apparatuses may alternatively be implemented or provided.

In particular, according to an embodiment of the present disclosure, the processes described above with reference to the flowcharts may be implemented as a computer software program. For example, an embodiment of the present disclosure includes a computer program product, which includes a computer program carried on a non-transitory computer-readable medium, where the computer program includes program codes for performing the methods shown in the flowcharts. In such an embodiment, the computer program may be downloaded and installed from a network through the communication apparatus 1109, or installed from the storage apparatus 1108, or installed from the ROM 1102. When the computer program is executed by the processing apparatus 1101, the above functions defined in the methods of the embodiments of the present disclosure are performed.

It should be noted that, the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program that can be used by or in combination with an instruction execution system, apparatus, or device. In the present disclosure, the computer-readable signal medium may include a data signal that propagates in a baseband or as a part of a carrier and carries computer-readable program codes. The data signal propagating in such a manner may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained on the computer-readable medium may be transmitted by any suitable medium, including but not limited to: a wire, an optical cable, RF (radio frequency), etc., or any suitable combination thereof.

In some implementations, the electronic device may communicate using any currently known or future developed network protocol, such as HTTP (HyperText Transfer Protocol), and may be interconnected with digital data communication (for example, a communication network) in any form or medium. Examples of the communication network include a local area network (“LAN”), a wide area network (“WAN”), an internetwork (for example, the Internet), and an end-to-end network (for example, an ad hoc end-to-end network), as well as any currently known or future developed networks.

The above computer-readable medium may be included in the above electronic device, or may exist alone without being assembled into the electronic device.

The above computer-readable medium carries one or more programs, and when the one or more programs are executed by the electronic device, the electronic device is caused to: display the data analysis page, where the data analysis page includes the conversation interaction region; and in response to the trigger operation for the first question text inputted in the conversation interaction region, display the first reply content obtained for the first question text in the conversation interaction region, where the first question text is used for describing the analysis target, the first reply content includes at least one analysis indicator, and different analysis indicators have different analysis dimensions.

The computer program code for performing the operations of the present disclosure may be written in one or more programming languages or a combination thereof. The above programming languages include, but are not limited to, object-oriented programming languages such as Java, Smalltalk, C++, and also include conventional procedural programming languages such as “C” language or similar programming languages. The program code may be executed entirely on a user's computer, partly executed on the user's computer, executed as an independent software package, partly executed on the user's computer and partly executed on a remote computer, or entirely executed on a remote computer or a server. In the case involving the remote computer, the remote computer may be connected to the user's computer through any kind of network, including a local area network (LAN) or a wide area network (WAN), or may be connected to an external computer (for example, connected through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in the reverse order, depending upon the functionality involved. It should also be noted that, each block of the block diagrams and/or flowcharts, and combinations of blocks in the block diagrams and/or flowcharts, may be implemented by special purpose hardware-based systems that perform the specified functions or operations, or combinations of special purpose hardware and computer instructions.

The modules involved in the embodiments of the present disclosure may be implemented in software or hardware. The name of a module does not constitute a limitation on the module itself under certain circumstances.

The functions described above herein may be performed, at least partially, by one or more hardware logic components. For example, without limitation, available exemplary types of hardware logic components include: field Programmable Gate Array (FPGA), Application Specific Integrated Circuit (ASIC), Application Specific Standard Product (ASSP), System on Chip (SOC), Complex Programmable Logical device (CPLD), etc.

In the context of the present disclosure, the machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an illustration of the applied technical principles. Those skilled in the art should understand that the scope of disclosure involved in the present disclosure is not limited to the technical solutions formed by specific combinations of the above technical features, and should also cover other technical solutions formed by any combination of the above technical features or their equivalent features without departing from the above disclosed concept, for example, a technical solution formed by replacing the above features with technical features having similar functions disclosed in the present disclosure (but not limited to).

In addition, although operations are depicted in a particular order, it should not be understood that these operations are required to be performed in the specific order shown or in a sequential order. Under certain circumstances, multitasking and parallel processing may be advantageous. Similarly, although several specific implementation details are included in the above discussion, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments, individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely example forms for implementing the claims. Regarding the apparatus in the above embodiments, the specific manner in which each module performs an operation has been described in detail in the embodiments relating to the method, and will not be described in detail here.

1. A data analysis method, comprising:
displaying a data analysis page, wherein the data analysis page comprises a conversation interaction region;
displaying, in the conversation interaction region, first reply content obtained for first question text in response to a trigger operation for the first question text inputted in the conversation interaction region, wherein the first question text is used for describing an analysis target, the first reply content comprises at least one analysis indicator, and different analysis indicators have different analysis dimensions.

2. The method according to claim 1, further comprising:
searching in a chart library for whether there is a target chart matching the target analysis indicator in response to a trigger operation for second question text which is inputted in the conversation interaction region and is related to a target analysis indicator, wherein the second question text is used for querying the target chart corresponding to the target analysis indicator; and
displaying second reply content in the conversation interaction region in response to searching out the target chart, wherein the second reply content comprises the target chart.

3. The method according to claim 2, further comprising:
displaying a chart detail panel in a floating manner on an upper layer of the target chart in response to a trigger operation for a detail control in the target chart, wherein the chart detail panel comprises chart attribute information, and the chart attribute information is used for assisting a user in judging credibility of the target chart.

4. The method according to claim 2, wherein there are a plurality of the target charts, and displaying the second reply content in the conversation interaction region in response to searching out the target chart comprises:
displaying the second reply content in the conversation interaction region in response to searching out a plurality of the target charts, wherein the second reply content comprises a target chart with a highest matching degree and a switching control for switching a chart; and
switching, in the conversation interaction region, to displaying other target charts associated with a currently displayed target chart in response to a switching operation for the switching control.

5. The method according to claim 3, wherein displaying the second reply content in the conversation interaction region in response to searching out the target chart comprises:
determining whether there is a permission to browse the target chart in response to searching out the target chart;
displaying the second reply content in the conversation interaction region in response to determining that there is the permission to browse the target chart, wherein the second reply content comprises the target chart; and
displaying the second reply content in the conversation interaction region in response to determining that there is no permission to browse the target chart, wherein the second reply content comprises a chart name of the target chart, the detail control and an application control for acquiring the permission to browse the target chart.

6. The method according to claim 2, wherein the data analysis page further comprises an analysis parameter configuration region, the analysis parameter configuration region displays a configuration item configured for an analysis parameter corresponding to the analysis indicator, and the method further comprises:
displaying the second reply content in the conversation interaction region in response to failing to search out the target chart, wherein the second reply content comprises an analysis parameter determined for the target analysis indicator; and
filling the analysis parameter into the corresponding configuration item.

7. The method according to claim 6, further comprising:
displaying third reply content in the conversation interaction region in response to determining that the analysis parameter comprises analysis parameters of a plurality of indicator apertures, wherein the third reply content comprises an analysis parameter corresponding to each of the indicator apertures;
wherein filling the analysis parameter into the corresponding configuration item comprises:
filling the analysis parameter corresponding to the target indicator aperture into the corresponding configuration item in response to a trigger operation for an analysis parameter corresponding to a target indicator aperture.

8. The method according to claim 1, further comprising:
displaying fourth reply content in the conversation interaction region in response to a re-answer operation for reply content, wherein the fourth reply content comprises new content obtained for question text corresponding to the reply content.

9. The method according to claim 8, wherein displaying the fourth reply content in the conversation interaction region in response to the re-answer operation for the reply content comprises:
displaying the reply content and the fourth reply content in different preset display styles in response to the re-answer operation for the reply content.

10. An electronic device, comprising:
a processor, and
a non-transitory memory with instructions thereon,
wherein the instructions upon execution by the processor, cause the processor to:
display a data analysis page, wherein the data analysis page comprises a conversation interaction region;
display, in the conversation interaction region, first reply content obtained for first question text in response to a trigger operation for the first question text inputted in the conversation interaction region,
wherein the first question text is used for describing an analysis target, the first reply content comprises at least one analysis indicator, and different analysis indicators have different analysis dimensions.

11. The electronic device according to claim 9, wherein the processor is further caused to:
search in a chart library for whether there is a target chart matching the target analysis indicator in response to a trigger operation for second question text which is inputted in the conversation interaction region and is related to a target analysis indicator, wherein the second question text is used for querying the target chart corresponding to the target analysis indicator; and
display second reply content in the conversation interaction region in response to searching out the target chart, wherein the second reply content comprises the target chart.

12. The electronic device according to claim 11, wherein the processor is further caused to:
display a chart detail panel in a floating manner on an upper layer of the target chart in response to a trigger operation for a detail control in the target chart, wherein the chart detail panel comprises chart attribute information, and the chart attribute information is used for assisting a user in judging credibility of the target chart.

13. The electronic device according to claim 11, wherein there are a plurality of the target charts, and the processor is further caused to:
display the second reply content in the conversation interaction region in response to searching out a plurality of the target charts, wherein the second reply content comprises a target chart with a highest match degree and a switching control for switching a chart; and
switch, in the conversation interaction region, to displaying other target charts associated with a currently displayed target chart in response to a switching operation for the switching control.

14. The electronic device according to claim 13, wherein the processor is further caused to:
determine whether there is a permission to browse the target chart in response to searching out the target chart;
display the second reply content in the conversation interaction region in response to determining that there is the permission to browse the target chart, wherein the second reply content comprises the target chart; and
display the second reply content in the conversation interaction region in response to determining that there is no permission to browse the target chart, wherein the second reply content comprises a chart name of the target chart, the detail control and an application control for acquiring the permission to browse the target chart.

15. The electronic device according to claim 11, wherein the data analysis page further comprises an analysis parameter configuration region, the analysis parameter configuration region displays a configuration item configured for an analysis parameter corresponding to the analysis indicator, and the processor is further caused to:
display the second reply content in the conversation interaction region in response to failing to search out the target chart, wherein the second reply content comprises an analysis parameter determined for the target analysis indicator; and
fill the analysis parameter into the corresponding configuration item.

16. The electronic device according to claim 15, wherein the processor is further caused to:
display third reply content in the conversation interaction region in response to determining that the analysis parameter comprises analysis parameters of a plurality of indicator apertures, wherein the third reply content comprises an analysis parameter corresponding to each of the indicator apertures;
wherein the processor is further caused to:
fill the analysis parameter corresponding to the target indicator aperture into the corresponding configuration item in response to a trigger operation for an analysis parameter corresponding to a target indicator aperture.

17. The electronic device according to claim 10, wherein the processor is further caused to:
display fourth reply content in the conversation interaction region in response to a re-answer operation for reply content, wherein the fourth reply content comprises new content obtained for question text corresponding to the reply content.

18. The electronic device according to claim 17, wherein the processor is further caused to:
display the reply content and the fourth reply content in different preset display styles in response to the re-answer operation for the reply content.

19. A non-transitory computer-readable storage medium storing instructions that cause at least a processor to:
display a data analysis page, wherein the data analysis page comprises a conversation interaction region;
display, in the conversation interaction region, first reply content obtained for first question text in response to a trigger operation for the first question text inputted in the conversation interaction region, wherein the first question text is used for describing an analysis target, the first reply content comprises at least one analysis indicator, and different analysis indicators have different analysis dimensions.

20. The non-transitory computer-readable storage medium according to claim 19, wherein the processor is further caused to:
search in a chart library for whether there is a target chart matching the target analysis indicator in response to a trigger operation for second question text which is inputted in the conversation interaction region and is related to a target analysis indicator, wherein the second question text is used for querying the target chart corresponding to the target analysis indicator; and
display second reply content in the conversation interaction region in response to searching out the target chart, wherein the second reply content comprises the target chart.
